(19) United States
(12) Patent Application Publication
(10) Pub. No.: US 2016/0225356 A1
(43) Pub. Date: Aug. 4, 2016

(54) Dual Mode Tuner Display

(71) Applicant: D'Addario & Company, Inc., Farmingdale, NY (US)

(72) Inventors: James D'Addario, Old Westbury, NY (US); Robert J. Cunningham, Levittown, NY (US)

(21) Appl. No.: 15/007,471

(22) Filed: Jan. 27, 2016

Related U.S. Application Data
(60) Provisional application No. 62/109,825, filed on Jan. 30, 2015.

(51) Int. Cl. G10G 7/02

(52) U.S. Cl. CPC G10G 7/02

(57) ABSTRACT

A tuner, a display, and a method implement the steps of (a) illuminating a configuration of elements within a first pattern of elements to indicate the target frequency for tuning; (b) illuminating a configuration of elements within a different, second pattern in which the number of illuminated elements corresponds to the number of coarse increments of sharp or flat deviation or total coarse deviation of the sensed waveform fundamental frequency relative to the target frequency; and (c) upon tuning to less than the minimum coarse sharp or flat deviation relative to the target frequency, illuminating a configuration of elements within a different, third pattern in which the number of illuminated windows corresponds to the number of fine increments of deviation or total fine deviation relative to the target frequency. These steps are substantially simultaneously implemented for both sharp and flat deviation to arrive at a final tuning.

### RELATED APPLICATION

Applicant claims the benefit under 35 U.S.C. 119(e) of U.S. Provisional Application No. 62/109,825 for “Dual Mode Tuner Display”, filed Jan. 30, 2015.

### BACKGROUND

The present invention relates to music instrument tuners, and more particularly to a more informative and stable high accuracy display interface.

Known music instrument tuners can take a wide variety of forms, in both physical configuration and tuning logic. Tuners for stringed instruments are especially difficult to design, because during performances the strings themselves can change characteristics and the playing length can be changed when a capo is applied. The performer desires a tuner that operates conveniently, quickly, and accurately so retuning does not interrupt the mood and ambiance of the performance.

Such tuners can feature a body to be secured to, e.g., the neck of a guitar, a digital display screen facing the performer, physical or virtual buttons for selecting a target frequency, and an indicator (or meter) system on the screen showing the degree to which the frequency of a plucked string deviates from the target frequency. The indictor can be numeric or symbolic. However, known tuners of this type are limited in that the metering system is inherently coarse (+/−15 cents) or if designed for finer tuning, the metering is unstable.

### SUMMARY

These limitations are overcome with the present invention, according to which a fine meter is provided within a coarse meter on the same display screen.

Relatively coarse and fine indications of tuning accuracy between a sensed frequency and a target frequency are displayed on a screen having a plurality of patterns of illumination elements, such as windows and respective illumination sources for each window. This can take a variety of forms beyond tuners for stringed instruments, including a method for tuning, a standalone tuning device, a tuner integrated with another device, a mobile device application or a computer or web based application, a software application, and/or a tuner display screen. The term “sensed waveform” as used herein should be understood as any input to the tuner that is commensurate with the frequency of the tone generated by an instrument to be tuned.

From a general perspective, the improvement comprises (a) illuminating a configuration of elements within a first pattern of elements to indicate the selected target frequency for tuning; (b) illuminating a configuration of elements within a different, second pattern in which the number of illuminated elements corresponds to the number of coarse increments of deviation or total coarse deviation of the sensed waveform relative to the target frequency; and (c) upon tuning to less than the minimum coarse deviation relative to the target frequency, illuminating a configuration of elements within a different, third pattern in which the number of illuminated windows corresponds to the number of fine increments of deviation or total fine deviation of the sensed waveform relative to the target frequency. These steps are substantially simultaneously implemented for both sharp and flat deviation in different regions of the display to arrive at a final tuning.

In one display embodiment, the second pattern of elements for coarse metering includes two laterally spaced apart, parallel, linear arrays or columns of window bars and the third pattern of elements includes window bars for fine metering in a linear array or column with the same number of windows, situated in the space between the arrays or columns of the second pattern. In this embodiment, the arrays are arranged together in a matrix of six rows with an inner column between two outer columns. When the deviation is greater than a maximum indicated coarse deviation (for example >/=50 cents), all of the window bars in the outer columns are illuminated with a first color (e.g., red) and none of the windows in the inner column are illuminated. The number of illuminated red windows decreases as the frequency of the played waveform approaches the target frequency. When the deviation is within the smallest coarse deviation from target (for example <7 cents) all windows in the inner column are illuminated with the second color (e.g., green). The user can continue tuning and as the play frequency approaches the best accuracy deviation (for example >/=1 cent sharp and >/=1 cent flat), the number of illuminated green bars decreases to the same optimum configuration for both sharp and flat. Of course, other indications of optimized tuning can be provided.

In this manner, the outer two columns of red meter windows mimic a normal, commercially available tuner (to within say +/−4 or 5 cents from target, which most musicians consider “in tune”). When the user has reached that relatively coarse degree of tuning, the display turns green indicating that the user is “in tune enough” for normal circumstances. If the user desires more accuracy, the center column of windows turns on with green illumination and presents the opportunity for tuning to +/−0.5 to +/−1.0 cents accuracy.

As a standalone, a fine meter for tuning within a few cents would be annoyingly unstable (jittery). However, because the presently disclosed outer, coarse meter is stable and steady and easy to use, the high accuracy meter will not be as annoying as conventional high accuracy interfaces, especially if the inventive tuner is designed for +/−0.7 cents accuracy or better. The user can choose to ignore or disable the higher accuracy indication. If the high accuracy center illumination is annoying to the user or the user does not require high accuracy, a switch can override the high accuracy processing, whereby preferably all three columns would operate the same at the same time.

In one tuner embodiment, the tuner comprises a body; means operatively connected to the body for selecting a target frequency or pitch for tuning; an input for receiving a sensed waveform commensurate with a vibration frequency generated by an instrument to be tuned; a processor responsive to the means for selecting the target frequency and said input, for generating a signal commensurate with the deviation of the sensed waveform relative to the target frequency; and a display screen on the body, responsive to the processor. The input includes but is not limited to a transducer, microphone or direct input connection. The screen has a plurality of patterns of illumination elements, including a first pattern for displaying the selected target frequency for tuning; a second pattern in which a plurality of illumination elements corresponds to a plurality of coarse increments of deviation of the sensed waveform relative to the target frequency; and a third pattern in which a different plurality of illumination elements corresponds to a plurality of fine increments of deviation of the sensed waveform relative to the target frequency. The fine tuning is facilitated by the third pattern of illumination elements located adjacent to the second pattern of illumination elements.

Thus, for fine tuning, frequency deviation and response to changes in string tension are indicated to the musician by a combination of four patterns of illumination elements, with two adjacent, coordinated patterns in one region of the display screen associated with sharp deviations and a different two adjacent, coordinated patterns of illumination elements in another region of the display screen associated with flat deviations.

### BRIEF DESCRIPTION OF THE DRAWING

FIG. 1 is a top view of a representative music tuner in which the display can be embodied;

FIG. 2 is a front view of the tuner of FIG. 1, showing the display screen;

FIG. 3 is a bottom view of the tuner of FIG. 1, showing buttons by which the user can sequence through options;

FIG. 4 is detailed view of the display screen for one representative implementation of the present invention;

FIG. 5 is a schematic of an example of patterns of illumination windows or bars in the screen display of FIG. 4, showing changes in illumination configuration corresponding to the extent that the play frequency deviates either sharp or flat from the target frequency for coarse tuning followed by fine tuning;

FIG. 6 is a table that describes with words, the conditions shown in FIG. 5; and

FIG. 7 is a schematic of the functional components of the representative tuner shown in FIGS. 1-4.

### DETAILED DESCRIPTION

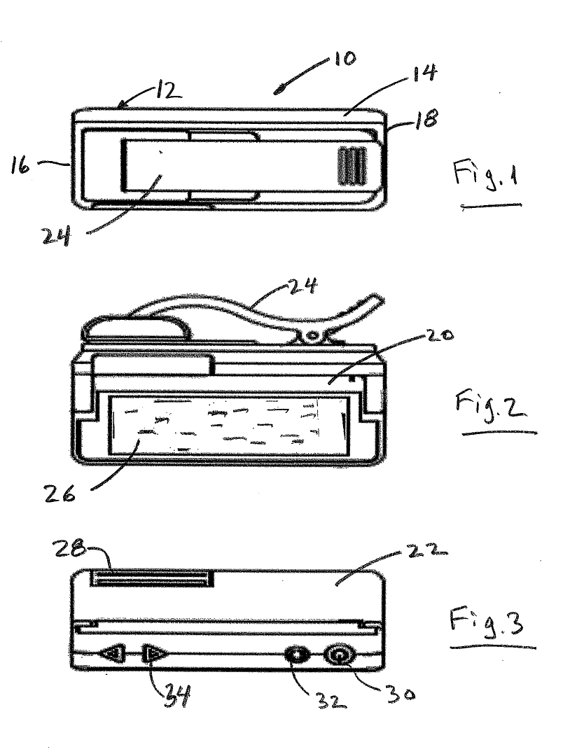

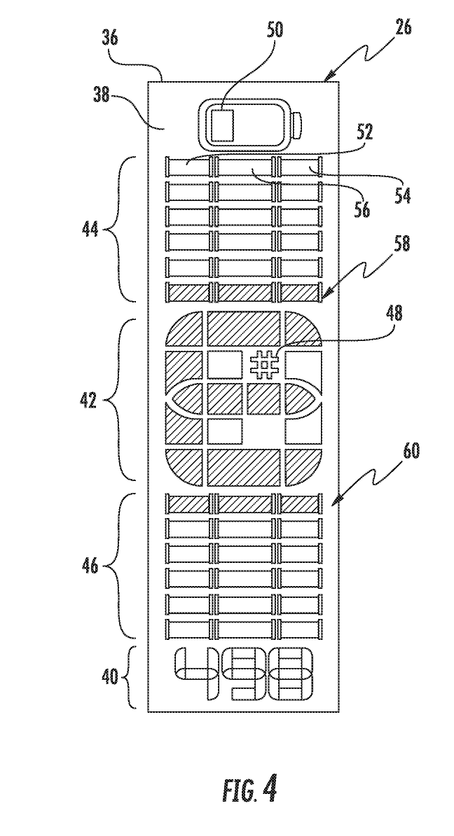

Various embodiments of the screen display and associated logic according to the present invention can be implemented in a wide variety of tuner types and bodies. FIGS. 1-3 show a representative tuner 10 having a body 12 with a top 14, left and right sides 16, 18, front 20, and bottom 22. As is typical for a guitar tuner, a spring loaded clip or the like 24 is present on the top whereby the top of the tuner can be secured against the neck, with the display screen 26 facing the user. A battery cover 28 opens to permit installation of a battery to power a digital processor in the body (not shown). Any type of means, such a button 30, toggle, lever, or the like can be provided to enable the user to select a target frequency or pitch for tuning. For present purposes, “target frequency” and “target pitch” are used synonymously. The tuner can have one or both of a microphone 32 for picking up audio waveforms, or the mechanical vibrations can be transmitted through the clamped contact with the neck of the instrument. In a tuner adapted for a foot pedal or table top, the audio vibrations could be delivered through a musical instrument cable interface to directly couple an instrument pick up with the tuner.

Accordingly, a tuner “body” can be any kind of single or multi-purpose housing or casing having an input for receiving a sensed waveform commensurate with a vibration frequency generated by an instrument to be tuned; a processor responsive to the means for selecting the target frequency and to the input waveform, for generating a signal commensurate with the deviation of the sensed waveform relative to the target frequency; and a display screen responsive to the processor.

Any configuration of on-off switch or target frequency selection can be provided. For example, switch 30 can simply be on-off, whereas the two triangular buttons indicated at 34 can be used to select the target frequency.

The processor is responsive to the means for selecting the target frequency and the pickup for generating a signal commensurate with the deviation of the sensed vibration frequency relative to the target frequency. The circuitry for processing the transducer signal from the pickup, comparing it with the selectable target frequency, and generating a signal commensurate with the deviation is well-known in the art. A representative implementation of this aspect of the invention can be readily derived from the examples and associated descriptions for FIG. 8 of U.S. Pat. No. 7,968,778, issued Jun. 28, 2011 for “Tuner with Capo”, and FIG. 24 of U.S. Pat. No. 8,334,449 issued Dec. 18, 2012 for “Polyphonic Tuner”, the disclosures of which are hereby incorporated by reference. The detailed logic and circuitry for implementing the innovative features of the present invention can readily be derived from the following description and associated FIGS. 4-7.

FIGS. 4-6 represent the innovative features of the present invention. One representative implementation of the invention is based on the layout and patterns of illumination windows or bars on a one screen display as shown in FIG. 4. The screen display 26 has a rectangular perimeter 36 within which a display area 38 contains a first pattern of illumination elements, such as windows or bars 40 or 42, to indicate the selected target frequency for tuning. One or both of Hertz frequency 40 or the corresponding note and/or octave 42 can be provided as the first pattern. Preferably, the first type of pattern 40 or 42 is in a central region of the screen area. In the illustrated embodiment, the upper region 44 is associated with sharp deviations of the play frequency relative to the target frequency, and the lower region 46 is associated with flat deviation relative to the target frequency. The screen display 36 including illumination elements would usually be substantially planar, as in other digital devices such as smartphones or the like, but could alternatively include raised illumination elements.

The present description will proceed with a more detailed explanation of the way in which the region 44 illuminates to help the user tune the instrument while reducing the deviation from sharp toward zero deviation, but it should be appreciated that the lower region is illuminated with the same logic and that during the tuning operation the illumination may shift back and forth between the upper 44 and lower 46 regions until the user is satisfied with the accuracy of tuning.

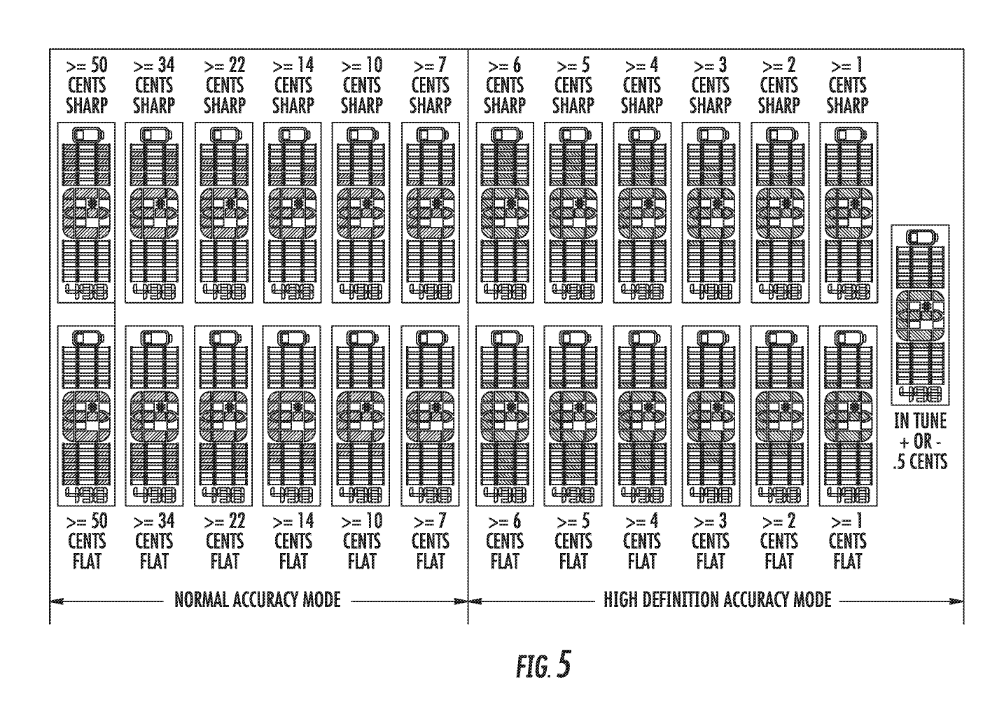

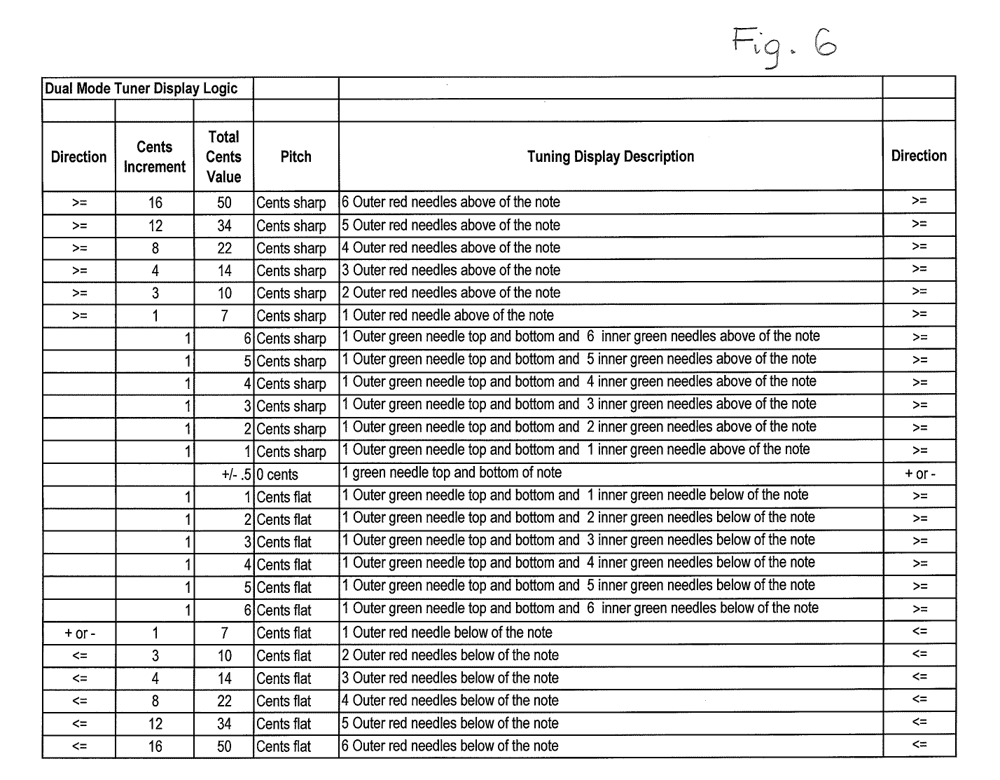

As used herein, a pattern of illumination elements means the fixed plurality of physical or virtual elements, such a windows and associated sources of illumination, that are employed for a given function in a particular region such as 42, 44, or 46. A pattern generally consists of at least one array (such as a row or column or arc) of individual illumination elements. The patterns in the sharp and flat regions 44, 46 can be illuminated in many configurations, each illuminated configuration depending on the extent of deviation of the play frequency relative to the target frequency. FIG. 4 shows one illuminated configuration, whereas FIG. 5 shows 12 configurations indicating different increments of sharp deviation (upper set) and 12 configurations indicating different increments of flat deviation (lower set) with the right-most configuration showing the configuration of FIG. 4, corresponding to maximum accuracy.

A very high degree of accuracy can be obtained according to the present invention, by use of coordinated illumination configurations whereby tuning can be performed at a relatively coarse degree of accuracy and, once this is achieved, further tuning can be achieved to a finer degree of accuracy with coordinated visualization in the same region 44, 46.

A tuning indicator is shown at 48 and the switch 50 can be set in one position for utilization of only the coarse tuning function, or set in another position where both the coarse and fine tuning are coordinated. Alternatively, the switch could be elsewhere and the battery level displayed at 50.

In region 44 a second pattern of a plurality of illumination windows is provided, in which the number of illuminated windows corresponds to the number of relatively large increments of deviation of the sense vibration frequency relative to the target frequency. In the illustrated embodiment, the second pattern is in the form of a linear array of a column of six windows indicated by end window 52 and another column of six windows indicated by end window 54, which are laterally spaced apart in parallel. The fine tuning is implemented with yet another pattern of illumination windows adjacent to the pattern for coarse tuning. In the illustrated embodiment, this pattern has the same number of illumination windows, in a column between the columns at 52 and 54, as represented by the end window 56, in parallel to the outer columns.

It should be appreciated that each column could have any plurality of illumination windows but, generally, at least five are preferred, and the windows can be shaped other than rectangular.

In the aggregate, the illumination windows in region 44 define a matrix of six rows by three columns. As will be described in greater detail below, the two coarse illumination windows in outer or left and right columns represented by 52 and 54 in any given row will illuminate together without any illumination of any of the windows in the inner or center column represented by 56. However, the end row 58 is of special significance as the target frequency is approached.

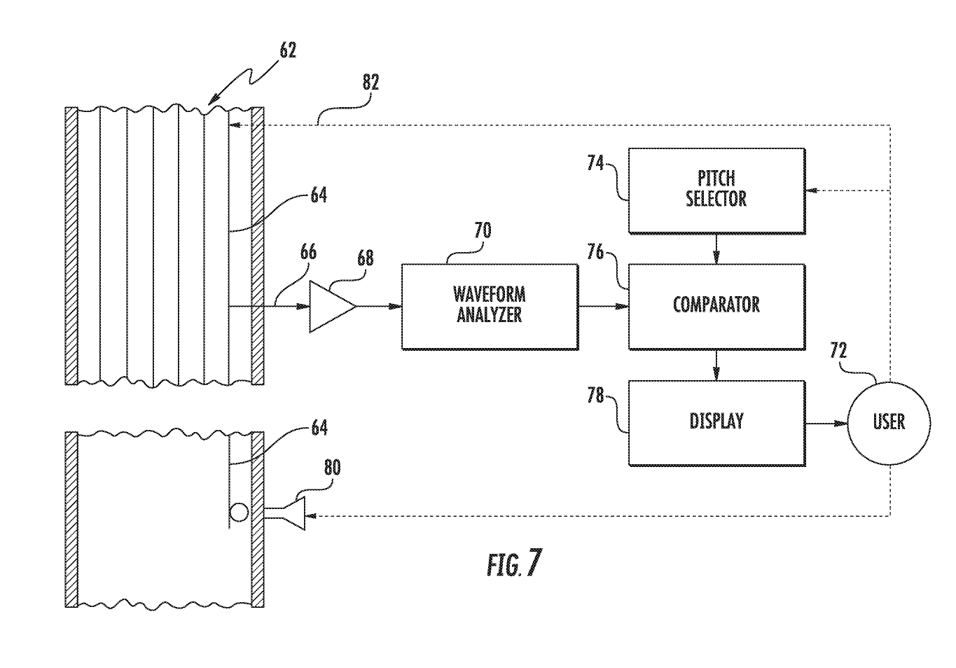

The distinction between coarse tuning associated with the outer columns per 52, 54 for a given target frequency such as 42 can be indicated in one color, such as red, whereas the further tuning in the fine accuracy regime can be represented by illumination in a different color such as green. In FIG. 5 the relatively dark shading is indicative of the color red, whereas the relatively light shading is indicative of the color green. In general, one can appreciate from FIGS. 5 and 6, that a distinction is made between the total cents value deviation from the target associated with a given illumination configuration, and the cents increment as between one illumination configuration and the next incremental display of illumination configuration.

Moving from left to right in FIG. 5 and from top to center in FIG. 6, the tuning sequence is illustrated for reducing the sharp deviation relative to target, from greater than 50 cents sharp down to less than 1 cent sharp. In the course tuning regime, the smallest cents increment between any two illumination arrays should be 2 or 3 cents, with 3 cents illustrated (>=10 cents to >=7 cents), whereas the largest cents increment in the fine tuning regime should be 1 or 2 cents. In the illustrated embodiment, each increment is 1 cent. In general, each increment associated with the fine tuning array (third pattern in center column) should be smaller than the smallest increment associated with the coarse array (second pattern in outer columns), but this is not limiting.

In the illustrated embodiment, for a total deviation of at least 7 cents, the same number of illumination windows in the left and right columns are illuminated in red, with none of the windows in the center column illuminated, whereas for a total deviation of less than 7 cents, none of the windows in the outer columns are illuminated in red and at least one window in the center column is illuminated in green.

With reference to FIG. 4, in sharp region 44 the row 58 closest to the central region 42 is a transition row which switches to totally green when the fine accuracy deviation is less than 7 cents sharp. No windows are illuminated in the flat region 46 if the total deviation is at least 7 cents sharp, but when the fine tuning is initiated, the outer windows of the transition row 60 of the flat region 46 illuminate in green. As the fine tuning in the sharp region 44 improves, fewer windows in the center column are illuminated. (In the center column of the display for high accuracy tuning as represented in the black and white line drawing of FIG. 5, white windows indicate no illumination whereas the windows in gray shade indicates green illumination). Ultimately, if the user seeks tuning within plus or minus 0.5 cents, as shown by the right-most illumination in FIG. 5, the transition rows 58, 60 in both the sharp and flat regions 44, 46 will be illuminated in green.

In this embodiment, the coarse tuning has a minimum total deviation (e.g., 7 cents sharp) and the fine tuning has a maximum total deviation (less than 7 cents sharp). With a given total deviation greater than the minimum total coarse deviation, the same number of windows in the coarse array are illuminated in one color (red) with none of the windows in the fine pattern illuminated, whereas with a total deviation of less than the minimum coarse deviation none of the windows in the coarse array are illuminated in red and at least one window in the fine array is illuminated in another color (green).

It should be appreciated that the illumination logic can be implemented in different shapes and relationships, i.e., not necessarily a rectangular screen and rectangular windows, with the target frequency displayed anywhere on or off the same screen. In general, however, the screen display will have a first pattern of illumination elements that displays a target frequency for tuning, a distinct second pattern of illumination elements that displays a variable subset of illumination elements in a first color for coarse tuning, a third pattern of illumination elements different from the second pattern of illumination elements, that displays a variable subset of illumination elements in a second color for fine tuning, wherein the third pattern of illumination elements is adjacent to the second pattern of illumination elements.

The associated method includes illuminating one pattern of a plurality of illumination elements in which the number of illuminated elements corresponds to the number of relatively coarse increments of deviation (or total deviation) of the cents vibration frequency relative to the target frequency. After illuminating the one pattern of illumination elements, illuminating another pattern of a plurality of illumination elements in which the number of illuminated elements in the other pattern corresponds to the number of relatively fine increments of deviation (or total deviation) of the sensed vibration frequency relative to the target frequency.

FIG. 7 represents the method schematically. A guitar neck 62 is longitudinally spanned by six strings, one of which is designated at 64. When the string is plucked a waveform is generated and travels acoustically or otherwise to a transducer, such as microphone or other pickup 68 operatively connected to neck or string 64. The sensed waveform is delivered as an input to the waveform analyzer 70. In a known manner, the waveform analyzer 70 digitally processes the waveform input to extract the fundamental play frequency. Also in a known manner, the waveform analyzer 70 can determine from the sensed waveform, the closest musical pitch (i.e., fundamental frequency) that is typical for a particular string of the associated instrument, and thus automatically select a target frequency. Alternatively or optionally, the user 72 selects the target frequency or pitch using a button or the like at 74. In either case, the comparator 76 determines the deviation of the play frequency associated with the sensed waveform at 70 relative to the target frequency. The display processor 78 illuminates the light pattern on the display screen such as shown in FIG. 4, in accordance with the logic described above.

Depending on the extent of deviation, the user adjusts the string tension via peg 80 (only one of the six strings and pegs are shown), and then plucks the string 64 again as indicated at 82. This sequence is repeated for this string 64 with the display changing as shown in FIG. 5 until the user is satisfied with the deviation, and then repeated for the other strings.

1. In a music tuner with a display screen including a pattern of illumination elements that are selectively illuminated by an associated digital processor to indicate a deviation of a fundamental frequency of a sensed waveform relative to a tuning target frequency, the improvement comprising that said display screen has a plurality of patterns of illumination elements, including
a first pattern for displaying the target frequency;
a second pattern in which a plurality of illumination elements corresponds to a plurality of coarse increments of deviation of the sensed waveform relative to the target frequency;
a third pattern in which a different plurality of illumination elements corresponds to a plurality of fine increments of deviation of the sensed waveform relative to the target frequency;
wherein the third pattern of illumination elements is adjacent to the second pattern of illumination elements.

2. The music tuner of claim 1, wherein the second pattern of illumination elements includes a linear array and the third pattern of illumination elements is an adjacent linear array.

3. The music tuner of claim 2, wherein the second pattern of illumination elements includes two laterally spaced apart, parallel, linear arrays and the third pattern of illumination elements is situated in said space, parallel to the second pattern.

4. The music tuner of claim 3, wherein each linear array has the same number of illumination elements.

5. The music tuner of claim 1, including
a fourth pattern in which a plurality of illumination elements corresponds to a plurality of coarse increments of deviation of the sensed waveform relative to the target frequency;
a fifth pattern adjacent to the fourth pattern, in which a different plurality of illumination elements corresponds to a plurality of fine increments of deviation of the sensed waveform relative to the target frequency;
wherein each increment of deviation associated by the processor with successive illumination elements in the second pattern is sharp by at least two cents, each increment of deviation associated by the processor with successive illumination elements in the third pattern is sharp by less than two cents, each increment of deviation associated by the processor with successive illumination elements in the fourth pattern is flat by at least two cents, and each increment of deviation associated by the processor with successive illumination elements in the fifth pattern is flat by less than two cents.

6. The music tuner of claim 1, wherein
a. each array of the second pattern and the third pattern has at least five illumination elements responsive to the processor, with the patterns in the aggregate defining at least five parallel rows of five illumination elements each in three parallel columns;
b. the coarse pattern of illumination elements has an illuminated configuration corresponding to a minimum coarse deviation from the target frequency and the fine pattern of illumination elements has an illuminated configuration corresponding to a maximum fine deviation from the target frequency; and
c. for a total deviation of more than said minimum coarse deviation from the target frequency, the illumination configuration of the second pattern is in one color with none of the third pattern illuminated, whereas for a total deviation of less than said minimum fine deviation from the target frequency none of the illumination elements in the second pattern are illuminated in said one color and the said third pattern has an illumination configuration in a different color.

7. The music tuner of claim 1, wherein
a. each array of the second pattern and the third pattern has at least five illumination elements responsive to the processor, with the patterns in the aggregate defining at least five parallel rows of five illumination elements each in three parallel columns;
b. the coarse pattern of illumination elements has an illuminated configuration corresponding to a minimum coarse deviation from the target frequency and the fine pattern of illumination elements has an illuminated configuration corresponding to a maximum fine deviation from the target frequency; and
c. for a deviation of more than said minimum coarse deviation from the target frequency, the same number of illumination elements in each column of the second pattern are illuminated with none of the third pattern illuminated, whereas for a deviation of less than said minimum coarse deviation from the target frequency none of the illumination elements in the second pattern are illuminated and at least one illumination element in the third pattern is illuminated.

8. A method for tuning a musical instrument by observing changes in a display of relatively coarse and fine indications of tuning accuracy between a sensed waveform produced by the instrument and a target frequency as displayed on a screen having a plurality of patterns of illumination elements, while adjusting a tuning mechanism on the instrument, comprising:
a. illuminating a configuration of elements within a first pattern of illumination elements to indicate the target frequency;
b. illuminating a configuration of elements within a different, second pattern of a plurality of illumination elements, said configuration corresponding to the number of coarse increments of deviation or total deviation of the sensed waveform relative to the target frequency;
c. upon tuning to less than the minimum coarse deviation relative to the target frequency, illuminating a configuration of elements within a different, third pattern of a plurality of illumination elements, said configuration corresponding to the number of fine increments of deviation of the sensed waveform relative to the target frequency.

9. The method of claim 8, wherein illumination of the second pattern is in a first color and illumination of the third pattern is in a second color.

10. The method of claim 9, wherein none of the illumination elements in the second pattern is illuminated with the first color when the deviation is less than the smallest coarse increment of deviation from the target frequency.

11. The method of claim 10, wherein when the deviation is less than the smallest coarse increment of deviation from the target frequency at least one illumination element of the third pattern is illuminated with said second color.

12. The method of claim 11, wherein the third pattern is adjacent to the second pattern and at least one illumination element is part of the second pattern and part of the third pattern.

13. The method of claim 12, wherein
a. the second pattern includes two laterally spaced apart, parallel, linear arrays of elements and the third pattern is a linear array of elements;
b. each linear array has the same number of elements; and
c. the third pattern is situated in said space, parallel to the second pattern.

14. The method of claim 13, wherein
the second and third arrays are arranged together in a matrix of six rows comprising two outer rows with an inner column between two outer columns;
when the deviation is greater than a maximum indicated coarse deviation all of the elements in the outer columns are illuminated with the first color and none of the elements in the inner column are illuminated;
when the deviation is less than one coarse deviation increment from the minimum indicated coarse deviation only the outer columns at an end row are illuminated with the first color and none of the elements in the inner column are illuminated; and
when the deviation is less than the smallest coarse deviation increment at least some in the inner column are illuminated with the second color and no elements are illuminated in said first color.

15. The method of claim 14, wherein when the deviation is within the smallest fine deviation increment only said end row is illuminated, in only said second color.

16. The method of claim 15, wherein
illuminating a configuration of elements within the second pattern of a plurality of illumination elements, corresponds to the number of coarse increments of sharp deviation or total sharp deviation of the sensed vibration frequency relative to the target frequency;
upon tuning to less than the minimum coarse deviation relative to the target frequency, illuminating a configuration of elements within a different, third pattern of a plurality of illumination elements, corresponds to the number of fine increments of sharp deviation or total sharp deviation of the sensed vibration frequency relative to the target frequency; and said method further comprises:
d. illuminating a configuration of elements within a different, fourth pattern of a plurality of illumination elements, said configuration corresponding to the number of coarse increments of flat deviation or total flat deviation of the sensed vibration frequency relative to the target frequency;
e. upon tuning to less than the minimum coarse flat deviation relative to the target frequency, illuminating a configuration of elements within a different, fifth pattern of a plurality of illumination elements, said configuration corresponding to the number of fine increments of flat deviation or total flat deviation of the sensed vibration frequency relative to the target frequency.

17. The method of claim 8, wherein
the second and third patterns of illumination elements are adjacent and are illuminated in configurations indicating sharp deviations from the target frequency;
illuminating a configuration of elements within a different, fourth pattern of a plurality of illumination elements, said configuration corresponding to the number of coarse increments of flat deviation or total deviation of the sensed waveform relative to the target frequency;
upon tuning to less than the minimum coarse flat deviation relative to the target frequency, illuminating a configuration of elements within a different, fifth pattern of a plurality of illumination elements that is adjacent to the fourth pattern, said configuration corresponding to the number of fine increments of flat deviation of the sensed waveform relative to the target frequency.

18. A display screen for a music tuning meter including a display area containing a multiplicity of illumination elements, comprising:
a first pattern of illumination elements that displays a target frequency for tuning;
a distinct second pattern of illumination elements that displays a variably illuminated subset of illumination elements in a first color;
a third pattern of illumination elements, different from the second pattern of illumination elements, that displays a variably illuminated subset of illumination elements in a second color;
wherein the third pattern of illumination elements is adjacent to the second pattern of illumination elements.

19. The display screen of claim 18, wherein
the first pattern is in a central region of the display screen;
the second and third patterns are on one side region of the display screen, adjacent to the central region, for indicating sharp deviation of the sensed waveform relative to a target frequency;
a distinct fourth pattern of illumination elements that displays a variably illuminate subset of illumination elements in said first color, is in another side region of the display screen, adjacent to the central region and opposite said one region, for indicating flat deviation of the sensed waveform relative to the target frequency;
a fifth pattern of illumination elements in said other side region, different from the fourth pattern of illumination elements, that displays a variably illuminated subset of illumination elements in said second color;
wherein the fifth pattern of illumination elements is adjacent to the fourth pattern of illumination elements.

20. The display screen of claim 19, wherein
said third pattern of illumination elements is within said second pattern of illumination elements; and
said fifth pattern of illumination elements is within said fourth pattern of illumination elements.

21. The display screen of claim 20, wherein
the second and third patterns of illumination elements form a rectangular matrix of rows and columns, with the third pattern within the second pattern; and
the fourth and fifth patterns of illumination elements form a rectangular matrix of rows and columns, with the fifth pattern within the fourth pattern.
